(19) United States
(12) Patent Application Publication
(10) Pub. No.: US 2026/0290318 A1
(43) Pub. Date: Sep. 24, 2026

(54) SMART GLASSES CONTROL SYSTEM, METHOD AND SMART GLASSES BASED ON LARGE LANGUAGE MODELS

(71) Applicant: SOLOS TECHNOLOGY (SHENZHEN) LIMITED, Shenzhen (CN)

(72) Inventors: Chi Sum Yu, Shenzhen (CN); Kwok Wah Law, Shenzhen (CN); Kenneth Fan, Somerville, MA (US); Wai Kuen Kenny Cheung, Shenzhen (CN)

(21) Appl. No.: 19/687,221

(22) Filed: May 26, 2026

Related U.S. Application Data
(63) Continuation of application No. PCT/CN2024/141261, filed on Dec. 22, 2024.

(30) Foreign Application Priority Data
Jan. 9, 2024 (CN) 202410034795.1

(51) Int. Cl. G10L 13/08; G02B 27/01; G06F 3/041; G06F 3/16; G06F 16/3329; G06F 40/30; G10L 15/26

(52) U.S. Cl. CPC G10L 13/08; G02B 27/017; G06F 3/041; G06F 3/167; G06F 16/33295; G06F 40/30; G10L 15/26; G02B 2027/0138; G02B 2027/0178

(57) ABSTRACT

Smart glasses control system, control method and smart glasses based on LLMs are provided. The control system includes smart glasses, a smart mobile terminal and a cloud server. The smart glasses obtain image data through a camera, obtain a first speech of a user, and transmit the first speech and the image data to the cloud server through the smart mobile terminal. The first speech includes a question of the user. The cloud server converts the first speech to a first text, generates prompt information, obtains a second text including a reply to the question through the LLMs according to the first text, the prompt information and the image data, converts the second text to a second speech, and transmits, through the smart mobile terminal, the second speech to the smart glasses for playing. The application improves the intelligence and interactivity of the smart glasses.

### CROSS REFERENCE TO RELATED APPLICATIONS

This application is a continuation application of PCT application No. PCT/CN2024/141261 filed on Dec 22, 2024, which claims priority to Chinese Patent Application No. 202410034795.1, titled "SMART GLASSES CONTROL SYSTEM, CONTROL METHOD AND SMART GLASSES BASED ON LARGE LANGUAGE MODELS", filed on Jan 9, 2024. The contents of all of the aforementioned applications are incorporated by reference herein in their entirety.

### BACKGROUND

### 1. Technical Field

The present disclosure generally relates to the technical field of smart glasses, and particularly to a smart glasses control system based on large language models (LLMs), smart glasses based on LLMs, and a smart wearable device control method based on LLMs.

### 2. Description of Related Art

As the computer technology has advanced, the smart glasses are becoming more and more popular. However, the existing smart glasses are expensive, and in addition to their own functions as smart glasses, they usually only have the features of listening to music and making or answering calls. Hence, the existing smart glasses only have some simple features and low intelligence.

### SUMMARY

The embodiments of the present disclosure provide a smart glasses control system, smart glasses and smart wearable device control method based on large language models (LLMs), which aim to enrich the functions of the smart glasses, and improve the intelligence and interactivity of smart glasses.

An embodiment of the present disclosure provides a smart glasses control system based on LLMs. The control system includes: smart glasses, a smart mobile terminal and a cloud server. The smart glasses include: a microphone, a speaker, a camera and a wireless component, and the LLMs are configured on the cloud server or in the smart mobile terminal.

The smart glasses are used for: obtaining, through the camera, image data including at least one photo or video, obtaining, through the microphone, a first speech of a user, and transmitting, through the wireless component, the image data and the first speech to the smart mobile terminal. The first speech includes a question asked by the user. The wireless component includes a Bluetooth component and/or a WiFi component.

The smart mobile terminal is used for: transmitting the first speech and the image data to the cloud server.

The cloud server is used for: converting the first speech to a first text; performing semantic analysis on the first text, obtaining analyzed semantics, and generating prompt information based on the analyzed semantics; obtaining, through the LLMs, a second text according to the first text, the prompt information and the image data, wherein the second text comprises a reply to the question; converting the second text to a second speech; and transmitting the second speech to the smart mobile terminal.

The smart mobile terminal is further used for transmitting the second speech to the smart glasses.

The smart glasses are further used for, receiving the second speech through the wireless component, and playing the second speech through the speaker.

An embodiment of the present disclosure provides smart glasses based on LLMs. The smart glasses include a frame, at least one temple, a microphone, a speaker, at least one sensor, a processor and a memory.

The at least one temple is connected to the frame, and the processor is electrically connected to the microphone, the speaker, the at least one sensor and the memory.

One or more computer programs executable on the processor are stored in the memory, and the one or more computer programs include:

instructions for: obtaining, through the at least one sensor, sensing data, wherein the at least one sensor includes a camera, and the sensing data includes image data captured by the camera, wherein the image data include at least one photo or video;

instructions for obtaining, through the microphone, a first speech of a user, wherein the first speech includes a question asked by the user;

instructions for obtaining, through the LLMs, a second speech including a reply to the question, according to the first speech and the sensing data, wherein the LLMs are configured on the smart glasses, or a smart mobile terminal, or a cloud server; and

instructions for playing the second speech through the speaker.

An embodiment of the present disclosure provides a computer-implemented smart wearable device control method based on LLMs, applied to a smart mobile terminal. The control method includes:

receiving, through a first wireless network, a first speech and image data transmitted by the smart wearable device, wherein the first speech includes a question asked by a user, the first wireless network includes a Bluetooth or WiFi network, and the image data include at least one photo or video;

converting the first speech to a first text, performing semantic analysis on the first text, obtaining analyzed semantics, and generating prompt information based on the analyzed semantics;

obtaining, through the LLMs, a second text according to the image data, the first text and the prompt information, wherein the second text includes a reply to the question, and the LLMs are configured on the smart mobile terminal or a cloud server; and

converting the second text to a second speech, and transmitting, through the first wireless network, the second speech to the smart wearable device for playing.

Each embodiment of the present disclosure, through the above-mentioned control system using the LLMs, the human-machine task interactions based on capturing image data is realized on the smart glasses or smart wearable devices, thereby enriching the functions of the smart glasses. Furthermore, due to the scalability and self-creativity of the LLMs, the intelligence and interactivity of the smart glasses or smart wearable devices can be further improved.

### BRIEF DESCRIPTION OF THE DRAWINGS

In order to more clearly illustrate the technical solutions in this embodiment, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a schematic structural diagram of a smart glasses control system based on large language models (LLMs) according to one embodiment of the present disclosure;

FIGS. 2 and 3 are schematic diagrams of application scenarios of the control system shown in FIG. 1;

FIG. 4 is a schematic structural diagram of the smart glasses control system based on LLMs according to another embodiment of the present disclosure;

FIG. 5 is a schematic diagram of an internal structure of smart glasses according to one embodiment of the present disclosure;

FIG. 6 is a schematic diagram of an external structure of the smart glasses according to one embodiment of the present disclosure;

FIG. 7 is a flow diagram of a smart wearable device control method based on LLMs according to one embodiment of the present disclosure;

FIG. 8 is a schematic diagram of application example 1 of the control method shown in FIG. 7.

FIG. 9 is a schematic diagram of application example 2 of the control method shown in FIG. 7.

FIG. 10 is a schematic diagram of application example 3 of the control method shown in FIG. 7.

FIG. 11 is a schematic diagram of application example 4 of the control method shown in FIG. 7.

FIG. 12 is a schematic diagram of application example 5 of the control method shown in FIG. 7.

### DETAILED DESCRIPTION

In order to make the objects, features and advantages of the present disclosure more obvious and easier to understand, the technical solutions in this embodiment will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

In the following descriptions, the terms "including", "comprising", "having" and their cognates that are used in the embodiments of the present disclosure are only intended to represent specific features, numbers, steps, operations, elements, components, or combinations of the foregoing items, and should not be understood as excluding the possibilities of the existence of one or more other features, numbers, steps, operations, elements, components or combinations of the foregoing items or adding one or more features, numbers, steps, operations, elements, components or combinations of the foregoing items.

In addition, in the present disclosure, the terms "first", "second", "third", and the like are only used for distinguishing, and cannot be understood as indicating or implying relative importance.

Unless otherwise defined, all terms (including technical and scientific terms) used herein have the same meanings as commonly understood by those skilled in the art to which the embodiments of the present disclosure belong. The terms (e.g., the terms those defined in commonly used dictionaries) will be interpreted as having the same meaning as the contextual meaning in the relevant technology and will not be interpreted as having idealized or overly formal meanings, unless clearly defined in the embodiments of the present disclosure.

Referring to FIG. 1, FIG. 1 is a schematic structural diagram of a smart glasses control system based on large language models (LLMs) according to one embodiment of the present disclosure. As shown in FIG. 1, the control system 100 includes: smart glasses 110, a smart mobile terminal 120 and a cloud server 130.

The cloud server 130 may be a single server or a distributed server cluster composed of multiple servers.

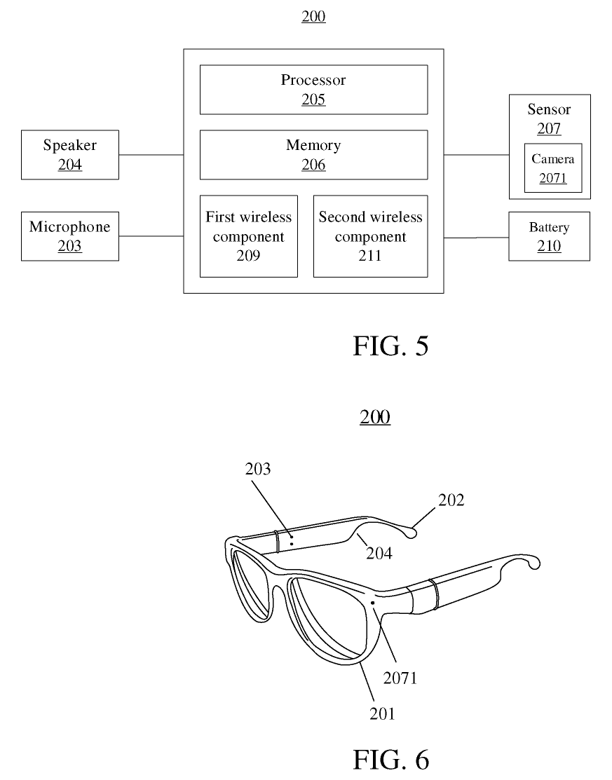

The smart glasses 110 may be open smart glasses including, for example, a microphone, a speaker, a camera, a wireless component and other components. The wireless component may include a Bluetooth component and/or a WiFi component. The specific structure of the smart glasses 110 may further be found in the relevant descriptions of the embodiments shown in FIG. 5 and FIG. 6 below.

The smart mobile terminal 120 may include, but is not limited to: a cellular phone, a smart phone, other wireless communication devices, a personal digital assistant, an audio player, other media players, a music recorder, a video recorder, a camera, other media recorders, a smart radio, a laptop computer, a personal digital assistant (PDA), a portable multimedia player (PMP), a Moving Picture Experts Group (MPEG-1 or MPEG-2) audio layer 3 (MP3) player, a digital camera, and smart wearable devices (such as a smart watch, a smart bracelet, etc.). The smart mobile terminal 120 is further installed with Android, iOS or other operating systems.

The smart glasses 110 are used for: obtaining image data through the camera, wherein the image data include at least one photo or video; obtaining a first speech of a user through the microphone; and transmitting, through the wireless component, the image data and the first speech to the smart mobile terminal 120. The first speech includes a question asked by the user. The image data may include: at least one static picture or photo, at least one dynamic video or image or photo, or a combination of pictures and images or photos.

The smart mobile terminal 120 is used for transmitting the first speech and the image data to the cloud server 130.

The cloud server 130 is used for: converting the first speech to a first text; performing semantic analysis on the first text, obtaining analyzed semantics, and generating prompt information based on the analyzed semantics; obtaining, through the LLMs, a second text including a reply to the question, according to the first text, the prompt information and the image data; converting the second text to a second speech; and transmitting the second speech to the smart mobile terminal 120.

The smart mobile terminal 120 is further used for transmitting the second speech to the smart glasses 110.

The smart glasses 110 are further used for: receiving the second speech through the wireless component, and playing the second speech through the speaker.

The LLMs may be configured on at least one of the smart glasses 110, the smart mobile terminal 120 and a cloud server 130. The LLM may include, but is not limited to, GAILLM (Generative Artificial Intelligence Large Language Model), or a MLLM (Multimodal Large Language Model).

The GAILLM may be, for example, but not limited to, OpenAI's ChatGPT, Google's Bard, or other models with similar functions. The MLLM may be, for example, but not limited to, BLIP-2, LLaVA, MiniGPT-4, mPLUG-Owl, LLaMA-Adapter-v2, Otter, Multimodal-GPT, InstructBLIP, VisualGLM-6B, PandaGPT, LaVIN, and other models with similar functions. The LLM may include multiple parts, which are trained based on different samples to respond to different task requests based on the image data. The tasks may include, but are not limited to, image identification, information sharing, phone calling, navigation, translation, sending messages, sending emails, searching the internet, calling web services, calling other third-party Software Development Kits (SDKs) to perform tasks provided by the SDKs, etc. For example, the task requests may include the questions of "Where is this photo in Hong Kong?", "What am I looking at?", "Which direction should I go?", "Log in to the website", or "Can you translate the Chinese text in this photo?" asked by the user.

Take the translation as an example, when the user captures a video (or one or more photos) through smart glasses 110 and speaks the first speech of "translating the English in the video into Chinese", the smart glasses 110 transmits the video / one or more photos and the first speech to the smart mobile terminal 120 through the wireless component, so as to forward the video and the first speech to the cloud server 130.

The cloud server 130 receives the video and the first speech, converts the first speech to the first text, performs the semantic analysis on the first text, obtains the analyzed semantics, generates the prompt information based on the analyzed semantics, and inputs the first text, the prompt information and the video into the LLMs. The prompt information includes a task request for translation.

According to the first text and the prompt information, the LLMs extract the text (such as "The next station is Guangzhou South Railway Station") in the photo(s)/video, perform the translation of the extracted text, with English as the source language and Chinese as the target language, and output the second text including the translated content (such as "下一站是广州南站"). Optionally, the LLMs may automatically recognize the source language when extracting the text in the video.

The cloud server 130 converts the second text outputted from the LLMs to a second speech, and transmits, through the smart mobile terminal 120, the second speech to the smart glasses 110 for playing.

Optionally, in other embodiments of the present disclosure, the smart mobile terminal 120 is further used for: obtaining positioning information, and transmitting the positioning information, the first speech and the image data to the cloud server 130. The positioning information is obtained by a satellite positioning system built into the smart mobile terminal 120. Alternatively, the positioning information may further be obtained by the smart glasses 110, and transmitted from the smart glasses 110 to the smart mobile terminal 120. The cloud server 130 is further used for, obtaining, through the LLMs, the second text according to the positioning information, the first text, the prompt information and the image data. The satellite positioning system may be GPS (Global Positioning System), or other positioning systems using Beidou satellite or other similar satellites.

Optionally, in other embodiments of the present disclosure, the cloud server 130 is further used for: obtaining chat history, and obtaining, through the LLMs, the second text according to the chat history, the first text, the prompt information and the image data.

Optionally, in other embodiments of the present disclosure, the smart mobile terminal 120 is further used for: obtaining positioning information, and transmitting the positioning information, the first speech and the image data to the cloud server 130. The positioning information is obtained by a satellite positioning system built into the smart mobile terminal 120. Alternatively, the positioning information may further be obtained by the smart glasses 110, and the smart glasses 110 transmit the obtained positioning information to the smart mobile terminal 120.

The cloud server 130 is further used for: obtaining chat history, and obtaining, through the LLMs, the second text according to the chat history, the positioning information, the first text, the prompt information and the image data.

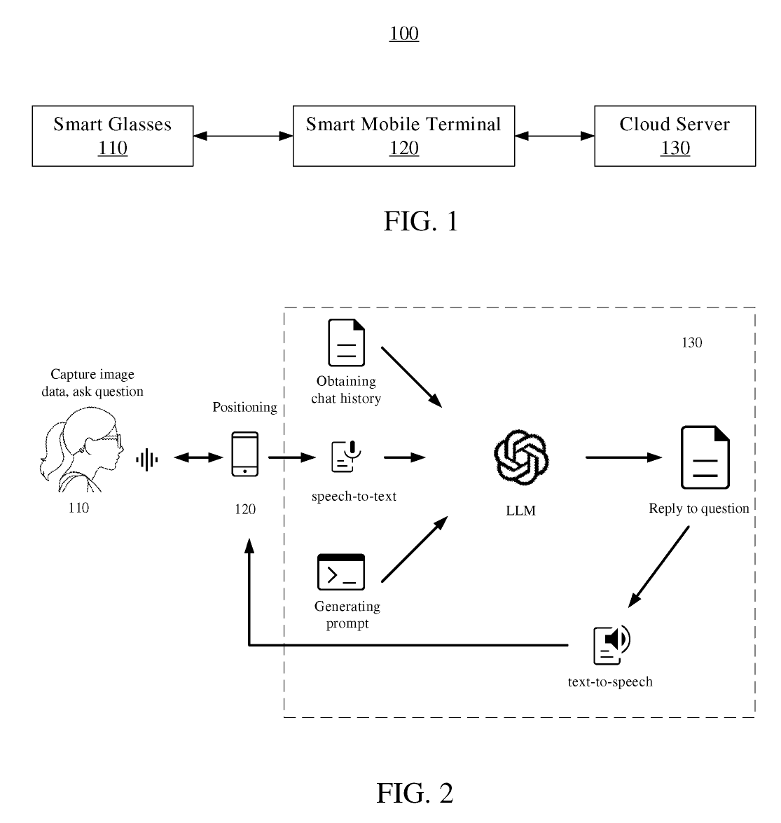

As shown in FIG. 2, in one practical example, when the user is shopping and spots a building (e.g., Shenzhen Ping An Financial Center) that he/she has never seen before, the user captures a photo/video using the camera on the smart glasses 110 that he/she wears, and then asks the smart glasses 110 a question such as "What building is this?". The smart glasses 110 obtain the voice of the user as the first speech through the built-in microphone, and then transmit the captured photo/video and the obtained first speech to the smart phone 120 through the Bluetooth.

The smart phone 120 obtains positioning information through the built-in positioning component, and then transmits the positioning information, the received photo/video and first speech to the cloud server 130. The positioning component may be, but not limited to, positioning component(s) based on the GPS or the Beidou satellite.

The cloud server 130 obtains the chat history of the user. The chat history includes: all text and/or photo/video data exchanged between the smart glasses 110, the smart phone 120, and the cloud server 130, during the current activation period of the chat feature of the smart glasses 110, or within the preset time frame while the user chats with the LLMs through the smart glasses 110.

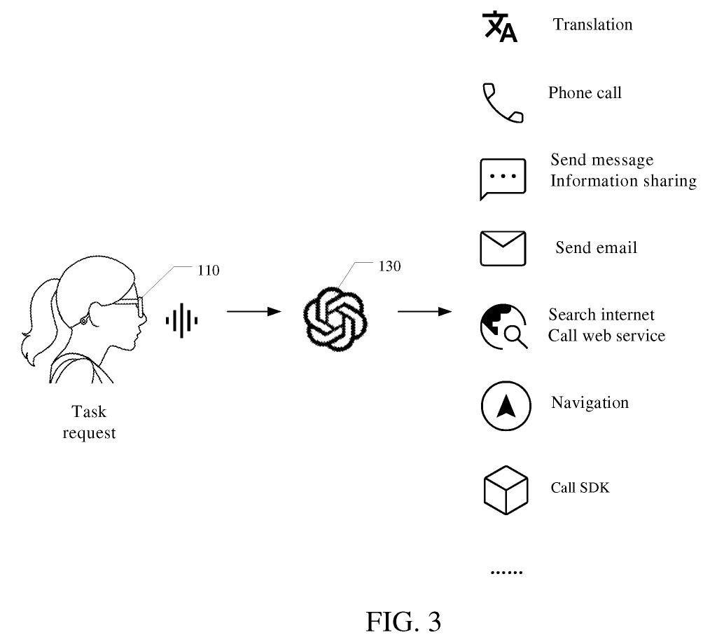

At the same time, the cloud server 130 converts the first speech to the first text, performs the semantic analysis on the first text, obtains the analyzed semantics, and generates the prompt information including the analyzed semantics based on the analyzed semantics. As shown in FIG. 3, in other application examples, based on the specific content of the analyzed semantics, in addition to the photo/video identification, the prompt information is further used to prompt the LLMs to perform at least one of the following tasks based on the photo/video: information sharing, phone calling, navigation, translation, message sending, email sending, internet searching, web service calling, and calling other third-party SDKs to perform tasks provided by the SDKs. The control system uses the LLMs through the cloud server 130 to process and explain the user voice commands in natural language, and then performs one or more tasks specified by the voice context like a personal assistant. The one or more tasks may be to, capture a photo/video with the camera and then request the model to find out the name of the building, make a phone call, send a message, send an email, search the interests, call a network service to obtain/post data, perform positioning or navigate, call other third-party SDKs to perform tasks provided by the SDKs, and so on. For example, when a user captures a building photo and speaks a task request of "I want to know the name of the building", the LLMs will respond to the task request of the user.

Then, the cloud server 130 inputs the chat history, the positioning information, the first text, the prompt information and the photo/video into the LLMs, and obtains the second text including a reply to the question outputted from the LLMs. The cloud server 130 converts the second text to the second speech, and transmits the second speech to the smart phone 120, so that the smart phone 120 transmits, through the Bluetooth, the second speech to the smart glasses 110 for playing. The LLMs use the positioning information to identify the building in the photo/video based on the prompt information, obtain the name of the building (e.g., Shenzhen Ping An Financial Center), and output the second text including the name of the building. Optionally, the second text may further include an introduction to the building, such as the history, architectural structure, and cultural stories and anecdotes of the building.

In another application example, the user captures a photo including a QR code through smart glasses 110, and speaks the first speech of "Log in to the website in the photo with the password 123456 in the name of Jack". The smart glasses 110 transmits, through the smart mobile terminal 120, the photo and the first speech to the cloud server 130. The cloud server 130 converts the first speech to a first text corresponding to the first speech, and performs the semantic analysis on the first text to obtain the prompt information including a task request for identifying the photo. Then, the cloud server 130 inputs the prompt information, the photo and the first text into the LLMs. According to the prompt information, the photo and the first text, the LLMs identify a network link in the QR code, generate and output the first task instruction and a second text including the information of "OK, logging in to the website XX shortly". The first task instruction is used to instruct actions of logging in to the website XX based on the identified network link, and the user account Jack and login password 123456 in the first text. The cloud server 130 executes the first task instruction, or forwards the first task instruction to the smart mobile terminal 120 for execution, or forwards, through the smart mobile terminal 120, the first task instruction to the smart glasses 110 for execution. At the same time, the cloud server 130 converts the second text to a second speech corresponding to the second text, and forwards, through the smart mobile terminal 120, the converted speech to the smart glasses 110 for playing.

After the smart glasses 110 play the second speech, the user further captures two photos through the smart glasses 110, and speaks the third speech of "What is the building in the photos?". The smart glasses 110 obtain the positioning information, and transmit the positioning information, the two photos and the third speech to the cloud server 130. The cloud server 130 converts the third speech to the third text corresponding to the third speech, and performs the semantic analysis on the third text to obtain the prompt information. The prompt information includes a task request for identifying photos. Further, the cloud server 130 inputs the prompt information, the two photos and the third text into the LLMs. According to the prompt information, the two photos and the third text, the LLMs identify the building(s) in the two photos, and output the fourth text including the introduction of the building(s). The cloud server 130 converts the fourth text to the fourth speech corresponding to the fourth text, and forwards, through the smart mobile terminal 120, the fourth speech to the smart glasses 110 for playing. In practical applications, the same one or more buildings, or multiple different buildings may be contained in the two photos.

After the smart glasses 110 play the fourth speech including the introduction of the building(s), the user further captures a video, and speaks the fifth speech of "Share this video, and the photo with only building out of the two photos captured before on the website XX" through the smart glasses 110. The smart glasses 110 transmit the video and the fifth speech to the cloud server 130. The cloud server 130 obtains the chat history of the user, converts the fifth speech to the fifth text corresponding to the fifth speech, and performs the semantic analysis on the fifth text to obtain prompt information including a task request for identifying actions. Further, the cloud server 130 inputs the chat history, the prompt information, the video and the fifth text into the LLMs. According to the chat history, the prompt information, the video and the fifth text, the LLMs identify the photo with only building from the two photos captured before as the target photo, generate and output the second task instruction and the sixth text including the information of "OK, preparing to share". The second task instruction is used to instruct the sharing of the video and the target photo to the above-mentioned website XX. The cloud server 130 executes the second task instruction, or forwards the second task instruction to the smart mobile terminal 120 for execution, or forwards, through the smart mobile terminal 120, the second task instruction to the smart glasses 110 for execution. At the same time, the cloud server 130 converts the sixth text to the sixth speech corresponding to the sixth text, and forwards, through the smart mobile terminal 120, the sixth speech to the smart glasses 110 for playing.

In other embodiments, optionally, while performing the above-mentioned series of actions, the cloud server 130 further generates chat logs in real time and stores the generated real-time chat logs in a chat history database for subsequent use (such as, in the task request for identifying actions).

In order to reduce the computing burden of the single server and improve the efficiency of data processing, in other embodiments, the above-mentioned cloud server may be a distributed server cluster composed of multiple servers. The multiple servers are configured with the LLMs (the model server), the chat history database (the storage server), the speech-to-text engine (the speech-to-text server), the text-to-speech engine (the text-to-speech server), and the prompt generator (the prompt server). Through the data interaction with the storage server, the speech-to-text server, the text-to-speech server and the prompt server, the model server completes the above-mentioned actions: obtaining the chat history, converting the speech to the text, generating the prompt information, obtaining the second text, and converting the text to the speech.

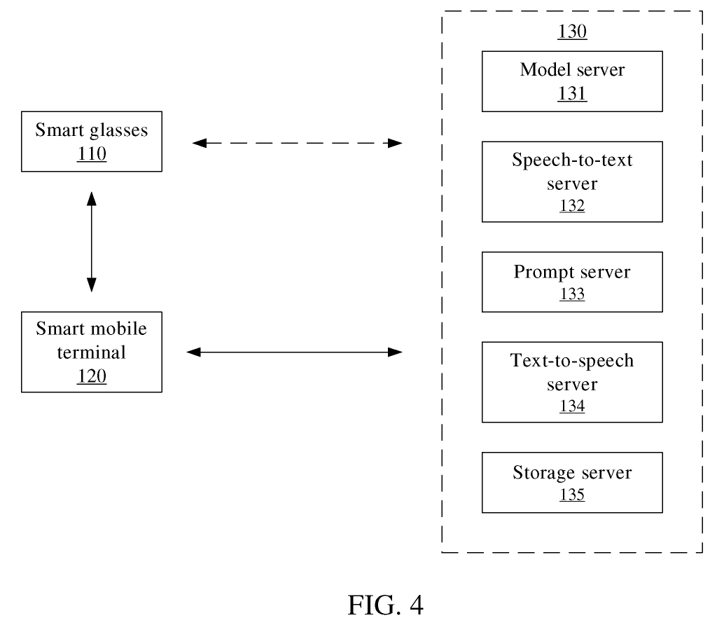

Optionally, in other embodiments of the present disclosure, as shown in FIG. 4, the cloud server 130 includes a model server 131, and the LLMs are configured on the model server 131.

The smart mobile terminal 120 is further used for: converting the first speech to the first text, performing the semantic analysis on the first text, obtaining the analyzed semantics, generating the prompt information based on the analyzed semantics, and transmitting the positioning information, the first text, the prompt information and the image data to the model server 131.

The model server 131 is used for: obtaining the chat history, obtaining, through the LLMs, the second text according to the chat history, the positioning information, the first text, the prompt information and the image data, and transmitting the second text to the smart mobile terminal 120.

The smart mobile terminal 120 is further used for converting the second text to the second speech.

That is, the actions of converting the first speech to a text, generating prompt information and converting the second text to a speech may be performed by the smart mobile terminal 120 using the speech-to-text engine, the prompt generator and the text-to-speech engine, which are built into the smart mobile terminal 120.

Optionally, in other embodiments, the cloud server 130 further includes: the speech-to-text server 132, the prompt server 133 and the text-to-speech server 134. The smart mobile terminal 120 is further used for: transmitting the first speech to the speech-to-text server 132, so as to convert, through the speech-to-text server 132, the first speech to the first text; transmitting the first text to the prompt server 133, so as to, through the prompt server 133, perform the semantic analysis on the first text, obtain the analyzed semantics and generate the prompt information based on the analyzed semantics; and transmitting the second text to the text-to-speech server 134, so as to convert the second text to the second speech through the text-to-speech server 134.

That is, the smart mobile terminal 120 may perform the actions of converting the first speech to a text, generating the prompt information and converting the second text to a speech, through the data interaction with the speech-to-text server 132, the prompt server 133, and the text-to-speech server 134.

Optionally, in other embodiments, the cloud server 130 further includes a storage server 135.

The smart mobile terminal 120 is further used for: generating real-time chat logs; and storing the real-time chat logs in the database configured on the smart mobile terminal 120, or transmitting the real-time chat logs to the storage server 135 for storing.

The model server 131 is further used for: obtaining the chat history transmitted by the smart mobile terminal 120, or obtaining the chat history from the storage server 135.

Specifically, a database for storing the chat history is configured on the smart mobile terminal 120 or the storage server 135. During a human-computer interaction (such as chatting) between the user and the LLMs, in the process of the data exchange between the smart mobile terminal 120, the smart glasses 110, and the various servers of the cloud server 130, the smart mobile terminal 120 may generate real-time chat logs based on the received or transmitted data and store the generated real-time chat logs in the database whenever data is received or transmitted. The real-time chat logs may include, but are not limited to, at least one of: received or transmitted image(s), received or transmitted speech(es), and received or transmitted text. In other embodiments, the real-time chat logs may further include, but are not limited to, at least one of: data interaction time, identification information of both parties in the data interaction, and identity information of the user. Alternatively, the real-time chat logs are generated by the smart glasses 110 or the model server 131, and are stored in the database on the storage server 135. In other embodiments, alternatively, the smart glasses 110, the smart mobile terminal 120, and each server in the cloud server 130 respectively generates its respective real-time chat logs and transmits them to the storage Server 135, and the storage server 135 organizes the received real-time chat logs and stores the received real-time chat logs in the database.

Optionally, in other embodiments, the cloud server 130 further includes: the model server 131, the speech-to-text server 132, the prompt server 133, the text-to-speech server 134 and the storage server 135, and the LLMs are configured on the model server 131.

The model server 131 is further used for: generating real-time chat logs, and transmitting the real-time chat logs to the storage server135 for storing.

The model server 131 is further used for: obtaining the chat history from the storage server 135; transmitting the first speech to the speech-to-text server 132, so as to convert, through the speech-to-text server 132, the first speech to the first text; transmitting the first text to the prompt server 133, so as to, through the prompt server 133, perform the semantic analysis on the first text, obtain the analyzed semantics and generate the prompt information based on the analyzed semantics; and transmitting the second text to the text-to-speech server 134, so as to convert the second text to the second speech through the text-to-speech server 134.

Optionally, in other embodiments, the cloud server 130 includes the model server 131, and the LLMs are configured on the model server 131.

The smart glasses 110 are further used for: converting the first speech to the first text, and transmitting the first text and the image data to the smart mobile terminal 120.

The smart mobile terminal 120 is further used for: performing the semantic analysis on the first text, obtaining analyzed semantics, generating prompt information based on the analyzed semantics, and transmitting the positioning information, the first text, the prompt information, and the image data to the model server 131.

The model server 131 is used for: obtaining the chat history, obtaining, through the LLMs, the second text according to the chat history, the positioning information, the first text, the prompt information and the image data, and transmitting the second text to the smart mobile terminal 120.

The smart mobile terminal 120 is further used for transmitting the second text to the smart glasses 110.

The smart glasses 110 are further used for converting the second text to the second speech.

Further, the cloud server 130 further includes: the prompt server 133 and the storage server 135. The smart glasses 110 are further used for transmitting the first text to the prompt server 133, so as to, through the prompt server 133, perform the semantic analysis on the first text, obtain the analyzed semantics and generate the prompt information based on the analyzed semantics. The model server 131 is further used for obtaining the chat history from the storage server 135.

Optionally, in other embodiments, the smart glasses 110 further include a positioning component, and the smart glasses 110 are used for: obtaining, through the positioning component, the positioning information, and transmitting the first speech, the positioning information and the image data to the cloud server 130. The cloud server 130 is further used for: obtaining, through the LLMs, the second text according to the positioning information, the first text, the prompt information and the image data.

Specifically, the smart glasses 110 may communicate directly with the cloud server 130, that is, while obtaining the first speech, the smart glasses 110 obtain the positioning information through their own positioning component, and transmit the first speech, the positioning information and the image data to the cloud server 130. The cloud server 130 receives the first speech, the positioning information and the image data, converts the first speech to the first text, performs the semantic analysis on the first text, obtains the analyzed semantics, generates prompt information based on the analyzed semantics, obtains, through the LLMs, the second text according to the positioning information, the first text, the prompt information and the image data, converts the second text into the second speech, and transmits the second speech to the smart glasses 110 for playing. Alternatively, the cloud server 130 may transmit the second speech to the smart mobile terminal 120 associated with the smart glasses 110, so as to, play the second speech through the smart mobile terminal 120, or forward the second speech to the smart glasses 110 through the smart mobile terminal 120.

Due to the direct communication between the smart glasses 110 and the cloud server 130, the data loss rate can be reduced, thereby improving the accuracy and efficiency of data processing.

Optionally, before positioning, the smart glasses 110 may determine whether a positioning component is configured on the smart glasses 110 according to the pre-stored device configuration information. When the positioning component is configured on the smart glasses 110, the smart glasses 110 obtain the positioning information through the positioning component. When the positioning component is not configured on the smart glasses 110, the smart glasses 110 search nearby connectable devices through the Bluetooth, establish a connection with the searched device, and obtain the positioning information through the connected device. Optionally, when the positioning component is not configured on the smart glasses 110, the smart glasses 110 determine whether the smart glasses 110 are connected with the associated smart mobile terminal 120, and when the smart glasses 110 are connected with the associated smart mobile terminal 120, the smart glasses 110 obtain the positioning information from the connected smart mobile terminal 120. Further, the smart glasses 110 may obtain the last transmitted positioning information associated with the user from the chat history database, and mark the obtained positioning information as the positioning information so that the cloud server 130 verifies the positioning information according to the mark, when the positioning component is not configured on the smart glasses 110, the smart glasses 110 are not connected with the associated smart mobile terminal 120, and no connectable device is searched. For example, verifying the positioning information may include: when the user is bound to a companion, the cloud server 130 requesting positioning information of the companion from smart glasses or a smart mobile terminal of the companion, and verifying the marked positioning information according to the positioning information of the companion. Specifically, when the positional deviation between the marked positioning information and the positioning information of the companion is less than a preset value, the smart glasses 110 obtain, through the LLMs, the second text according to the chat history, the marked positioning information, the first text, the prompt information and the image data; otherwise, the smart glasses 110 obtain, through the LLMs, the second text according to the chat history, the first text, the prompt information and the image data.

Optionally, for improving the security of data transmission, the smart glasses 110 may further authenticate the connectable device using the preset passwords, or the smart glasses 110 may connect only a connectable device in a preset safety list, before establishing the data connection with the connectable device.

Further, the smart glasses 110 are further used for transmitting the first speech to the smart mobile terminal 120, so as to generate, through the smart mobile terminal 120, the prompt information according to the first speech. The smart glasses 110 are further used for transmitting the prompt information, the first speech, the positioning information and the image data to the cloud server 130. The cloud server 130 is further used for: obtaining chat history, obtaining, through the LLMs, the second text according to the chat history, the positioning information, the first text, the prompt information and the image data.

Optionally, in other embodiments, the smart glasses further include at least one control button, and the at least one control button includes physical button(s) and/or a touch-sensor-based virtual button(s). The smart glasses 110 are used for: in response to an activation command, activating the chat feature on the smart glasses 110, wherein the activation command comes from the smart mobile terminal 120 or a virtual assistant program installed on the smart glasses 110; in response to a capture command, obtaining the image data through the camera, wherein the capture command is triggered by the user through a capture button in the at least one control button; outputting a first prompt sound to prompt the user to ask the question; in response to a listen command, initiating the microphone to detect the first speech, wherein the listen command is triggered based on an event of the user pressing and holding a chat button in the at least one control button; in response to a stop command, stopping the detection of the first speech, and outputting a second prompt sound to prompt the user that the speech detection is stopped, wherein the stop command is triggered based on an event of the user releasing the chat button, or an event of idle time of the microphone exceeding a preset time.

Optionally, while transmitting the first speech or the first text, the smart glasses 110 or the smart mobile terminal 120 may further transmit one or more kinds of sensing data obtained by the built-in sensors to the LLMs, so that the LLMs respond better to requests of the user. The one or more kinds of sensing data are selected from a group including: step count data of the pedometer, user posture(s), sensor data (such as, IMU (Inertial Measurement Unit) data, direction data of electronic compass, the data of touch sensor), and environmental data (such as temperature or humidity). For example, when the user asks "How much longer will it take me to walk to the location shown in the image?", the LLMs will combine the position of the identified location in the image with the step count data of the pedometer, to correctly answer the question of the user about the remaining time, such as "Half an hour more on foot, and you'll arrive".

In the embodiment, by using the LLMs, the human-machine task interactions based on capturing image data are realized on the smart glasses, thereby enriching the functions of the smart glasses. Furthermore, due to the scalability and self-creativity of the LLMs, the intelligence and interactivity of the smart glasses can be further improved. Further, since the smart glasses can position and forward the data through nearby connectable devices when the smart glasses are not configured with the wireless component or positioning component, the success rate of data processing can be improved.

Referring to FIGS. 5 and 6 , FIG. 5 is a schematic diagram of an internal structure of smart glasses based on LLMs according to one embodiment of the present disclosure, and FIG. 6 is a schematic diagram of an external structure of the smart glasses based on LLMs according to one embodiment of the present disclosure. For ease of description, only parts related to the embodiment of the present disclosure are shown in the figures. As shown in FIGS. 5 and 6, the smart glasses 200 include: a frame 201, at least one temple 202, at least one microphone 203, at least one speaker 204, at least one processor 205, at least one memory 206, and at least one sensor 207. The at least one sensor 207 includes a camera 2071. The camera 2071 may be provided on the left side of the frame 201 (as shown in FIG. 6), the right side of the frame 201, or the center of the frame 201, which is not specifically limited herein. FIGS. 5 and 6 are merely preferred examples. In practical applications, the smart glasses 200 may have fewer or more components than shown in FIGS. 5 and 6.

The frame 201 may be, for example, a front frame with a lens (e.g., a sunglass lens, a clear lens, or a corrective lens). The at least one temple 202 may include, for example, a left temple and a right temple.

The at least one temple 202 is connected to the frame 201, and the at least one processor 205 is electrically connected to the at least one microphone 203, the at least one speaker 204, the at least one memory 206, and the at least one sensor 207. The at least one microphone 203, the at least one speaker 204, the at least one processor 205, the at least one memory 206 and the at least one sensor 207 are provided in at least one temple 202 and/or frame 201. Preferably, the at least one temple 202 is detachably connected to the frame 201.

The processor 205 includes: a CPU (Central Processing Unit / Processor) and a DSP (Digital Signal Processor). The DSP is used to process the speech data obtained by the microphone 203. Preferably, the CPU is a MCU (Micro-controller Unit).

The memory 206 is a non-transitory memory, and specifically may include a RAM (Random Access Memory) and a flash memory component, and one or more computer programs executable on the processor 205 are stored in the memory 206. The one or more computer programs include: instructions for, obtaining, through the at least one sensor 207, sensing data, wherein the at least one sensor 207 includes a camera 2071, and the sensing data includes image data captured by the camera 2071; instructions for, obtaining a first speech of a user through the at least one microphone 203, wherein the first speech includes a question asked by the user; instructions for, obtaining, through the LLMs, a second speech including a reply to the question according to the first speech and the sensing data, wherein the LLMs are configured on the smart glasses, or a smart mobile terminal, or a cloud server; and instructions for, playing the second speech through the at least one speaker 204.

The LLMs may be the GAILLMs, the MLLMs, or other models with similar functions.

Optionally, in other embodiments of the present disclosure, the smart glasses 200 further include at least one control button 208 electrically connected to the processor 205, and the at least one control button includes physical button(s) and/or touch-sensor-based virtual button(s). The one or more computer programs further include: instructions for, in response to an activation command, activating chat feature on the smart glasses 200, wherein the activation command comes from the smart mobile terminal 120 associated with the smart glasses 200, or a virtual assistant program installed on the smart glasses 200; instructions for, in response to a capture command, obtaining the image data through the camera 2071, wherein the capture command is triggered by the user through a capture button in the at least one control button 208; instructions for, outputting a first prompt sound to prompt the user to ask the question; instructions for, in response to a listen command, initiating the at least one microphone 203 to detect the first speech, wherein the listen command is triggered based on an event of the user pressing and holding a chat button in the at least one control button 208; and instructions for, in response to a stop command, stopping the detection of the first speech, outputting a second prompt sound to prompt the user that the speech detection is stopped, and obtaining, through the LLMs, the second speech including the reply to the question according to the first speech and the sensing data, wherein the stop command is triggered based on an event of the user releasing the chat button or an event of idle time of the at least one microphone 203 exceeding a preset time.

Optionally, in other embodiments of the present disclosure, the at least one sensor 207 further includes a position sensor 2072 (not shown in FIGS. 5 and 6). The sensing data further includes positioning data of the smart glasses 200. The one or more computer programs further include: instructions for, obtaining, through the position sensor 2072, location information of the smart glasses 200 as the positioning data. The function of the position sensor 2072 is similar to that of the positioning component or satellite positioning system in the embodiments of the control system shown in FIGS. 1 and 4, and the position sensor 2072 specifically may be, but not limited to, a positioning component based on the GPS or the Beidou satellite.

Optionally, in other embodiments of the present disclosure, the one or more computer programs further include: instructions for, obtaining chat history of the user, and obtaining, through the LLMs, the second speech according to the first speech, the sensing data and the chat history.

Optionally, in other embodiments of the present disclosure, the smart glasses 200 further include a second wireless component 211 electrically connected to the processor 205. The one or more computer programs further include: instructions for, generating real-time chat logs, and storing the real-time chat logs in the memory 206, or transmitting, through the second wireless component 211, the real-time chat logs to the storage server for storing; and instructions for, obtaining the chat history from the memory 206 or the storage server.

Specifically, the second wireless component 211 includes a wireless signal transceiver and peripheral circuits, which may be specifically provided in an inner cavity of the frame 201 and/or at least one temple 202. The wireless signal transceiver of second wireless component 211 may, but is not limited to, use at least one of WiFi (Wireless Fidelity) protocol, NFC (Near Field Communication) protocol, ZigBee protocol, UWB (Ultra Wide Band) protocol, RFID (Radio Frequency Identification) protocol, and cellular mobile communication protocol (such as 3G/4G/5G, etc.) to perform the data transmission.

Optionally, in other embodiments of the present disclosure, the smart glasses 200 further include a first wireless component 209 electrically connected to the processor 205. Optionally, in some embodiments of the present disclosure, the first wireless component 209 may include at least one signal wireless transceiver and their peripheral circuits for short-range or low-power wireless communication, such as, Bluetooth, WiFi, and the like. The one or more computer programs further include: instructions for, obtaining, through the first wireless component 209, the positioning data from the smart mobile terminal; instructions for, transmitting, through the second wireless component 211, the first speech to a speech-to-text server, so as to convert, through the speech-to-text server, the first speech to a first text; instructions for, transmitting, through the second wireless component 211, the first text to a prompt server, so as to, through the prompt server, perform the semantic analysis on the first text, obtain analyzed semantics and generate the prompt information based on the analyzed semantics; instructions for, obtaining, through the LLMs, a second text including a reply to the question according to the prompt information, the first text, the sensing data and the chat history; and instructions for, transmitting, through the second wireless component 211, the second text to a text-to-speech server, so as to convert the second text to the second speech through the text-to-speech server.

Optionally, in other embodiments of the present disclosure, the one or more computer programs further include: instructions for, transmitting, through the first wireless component 209, the prompt information, the first text, the sensing data and the chat history to the smart mobile terminal, so as to obtain, through the LLMs on the smart mobile terminal, the second text including the reply to the question; or transmitting, through the second wireless component 211, the prompt information, the first text, the sensing data and the chat history to the model server, so as to obtain, through LLMs on the model server, the second text including the reply to the question.

Optionally, in other embodiments of the present disclosure, the smart glasses 200 may further include other input devices electrically connected to the processor 205, such as a power button, touch display screen(s), etc. Optionally, the touch display screen(s) may further be used as output devices for displaying the real-time chat logs in other embodiments, or chat history specified by the user.

Optionally, in other embodiments of the present disclosure, the smart glasses 200 further include: indicator light(s) and/or buzzer(s) electrically connected to the processor 205. The one or more computer programs further include: instructions for, outputting prompt information through the indicator light(s) and/or the buzzer(s), and the prompt information is used to indicate states of the smart glasses 200. The states include a working state and an idle state, and the working state includes: a starting speech pickup status, a speech pickup status, a completing pickup speech status, and a speech processing status. The indicator light(s) may be the LED (Light Emitting Diode) light(s).

Specifically, in addition to using beeps to indicate that the smart glasses are listening to the user speech, and to indicate that the speech is transmitted to the LLMs and is awaiting the response from the LLMs, the smart glasses may further utilize the LED indicator(s) to indicate whether the smart glasses are listening to the user speech (such as green light), waiting for the response from the LLMs (such as red light), or fully idle (lights off). Furthermore, after the speech obtained by the LLMs (such as the second speech) is played, when the chat feature of the smart glasses is automatically deactivated due to the microphone remaining idle beyond the preset duration, the LED indicator will be simultaneously turned off. At this time, when the user sees the LED indicator turn off, the user will know to reactivate the smart glasses to resume listening to the user speech by pressing and holding the virtual button or using the wake-up word(s).

Optionally, in other embodiments of the present disclosure, the at least one sensor 207 further includes at least one of: IMU sensor(s), temperature sensor(s), proximity sensor(s), humidity sensor(s), electronic compass(es), timer(s) and pedometer(s).

The one or more computer programs further include: instructions for, in response to a sensing data acquisition request of the model server, obtaining sensing data of the at least one sensor 207, and transmitting the obtained sensing data to the model server, so that the model server obtains, through the LLMs, the second text according to the chat history, the positioning information, the first text, the prompt information, the image data and the received sensing data. It is understandable that the output of the LLMs may be other text including a request for obtaining the sensing data. The model server generates the sensing data acquisition request according to the text including the request for obtaining the sensing data, and transmits the sensing data acquisition request to the smart glasses 200, so that the smart glasses 200 obtain sensing data requested by the sensing data acquisition request, in response to the sensing data acquisition request. For example, when the user asks "How much longer will it take me to walk to the location shown in the image?", the LLMs will output a text including a pedometer data acquisition instruction. The model server transmits a pedometer data acquisition request to the smart glasses 200 or the smart mobile terminal associated with the smart glasses 200, according to the pedometer data acquisition instruction, so as to obtain data of pedometer from the smart glasses 200 or the smart mobile terminal associated with the smart glasses 200. The model server inputs the obtained data of pedometer into the LLMs. According to the data of the pedometer (such as step count data) and the identified position of the object in the image(s), the LLMs calculate the time when the user arrives at the identified location, and output the second text including the information of "Half an hour more on foot, and you'll arrive".

Optionally, in other embodiments of the present disclosure, the smart glasses 200 further include a voice biometric module. The voice biometric module is used for identifying the user's identity using the obtained voiceprint of the user of the smart glasses 200, so as to enable the above-mentioned voice control function based on the smart glasses 200. Due to the fact that only the owner of the smart glasses can awaken the smart glasses to use the functions provided by the LLMs, the security of the device can be improved.

Further, the smart glasses 200 further include a battery 210 used to provide power support for the above-mentioned various electronic components of the smart glasses 200, such as the microphone(s) 203, speaker(s) 204, processor(s) 205, at least one memory 206, sensor(s) 207, and other components.

The aforementioned various electronic components of smart glasses are connected through a bus.

It should be noted that the relationship between the components of the above-mentioned smart glasses may be an alternative relationship or a superposition relationship. That is, all components in the above-mentioned embodiments are installed on the smart glasses, or some of the above-mentioned components are selectively installed according to requirements. When the relationship is the alternative relationship, the smart glasses are further provided with the one or more connection interfaces for connecting the peripheral devices, such as at least one of: a PS/2 interface, a serial interface, a parallel interface, an IEEE1394 interface, and a USB (Universal Serial Bus) interface. The function of the replaced component can be realized by the peripheral devices (such as external speakers, external sensors, etc.) connected to the connection interface.

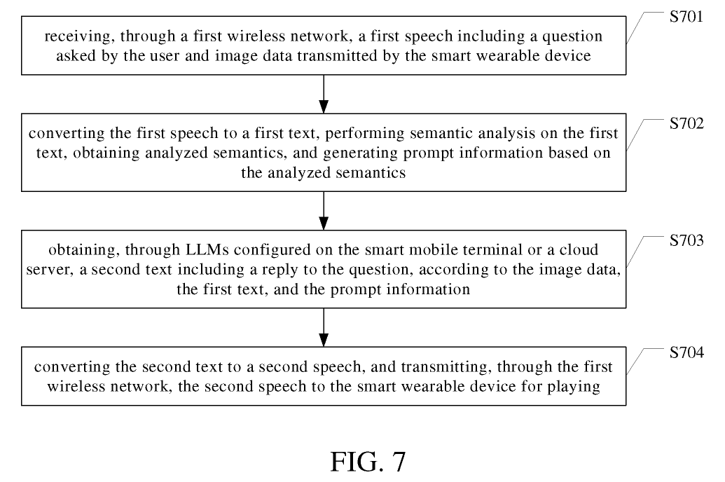

For details not covered in the above-mentioned embodiments of the smart glasses based on LLMs, please refer to the relevant descriptions in the above-mentioned embodiments shown in FIGS. 1 to 4 and the embodiments shown in FIGS. 7 to 12 below, which will not be described again here.

In the embodiment, by using the LLMs, the human-machine task interactions based on capturing image data are realized on the smart glasses, thereby enriching the functions of the smart glasses. Furthermore, due to the scalability and self-creativity of the LLMs, the intelligence and interactivity of the smart glasses can be further improved. Further, since the smart glasses can position and forward the data through nearby connectable devices when the smart glasses are not configured with the wireless component or positioning component, the success rate of data processing can be improved.

Referring to FIG. 7, FIG. 7 is a flow diagram of a smart wearable device control method based on LLMs according to one embodiment of the present disclosure. The control method is applied to a smart mobile terminal, such as the smart mobile terminal 120 in the embodiments shown in FIGS. 1 and 4. The smart wearable device may achieve the smart wearable device control method through data interaction with the smart mobile terminal 120. The smart wearable device may include but is not limited to, smart safety helmets, smart earphones, smart earrings, smart watches, and smart glasses shown in FIGS. 5 and 6. As shown in FIG. 7, the control method includes the following steps:

S701, receiving, through a first wireless network, a first speech including a question asked by the user and image data transmitted by the smart wearable device, wherein the first wireless network includes Bluetooth and/or WiFi networks, and the image data include at least one photo or video;

S702, converting the first speech to a first text, performing semantic analysis on the first text, obtaining analyzed semantics, and generating prompt information based on the analyzed semantics;

S703, obtaining, through LLMs configured on the smart mobile terminal or a cloud server, a second text including a reply to the question, according to the image data, the first text, and the prompt information; and

S704, converting the second text to a second speech, and transmitting, through the first wireless network, the second speech to the smart wearable device for playing.

Optionally, in other embodiments of the present disclosure, the control method further includes: obtaining positioning information and/or chat history of the user; and obtaining, through the LLMs, the second text, according to the image data, the first text, the prompt information, and the positioning information and/or chat history.

Optionally, in other embodiments of the present disclosure, the step of converting the first speech to the first text specifically further includes: transmitting, through a second wireless network, the first speech to a speech-to-text server, so as to convert, through the speech-to-text server, the first speech to the first text.

The step of performing the semantic analysis on the first text, obtaining the analyzed semantics, and generating the prompt information based on the analyzed semantics, specifically further includes: transmitting, through the second wireless network, the first text to a prompt server, so as to, through the prompt server, perform the semantic analysis on the first text, obtain the analyzed semantics and generate the prompt information based on the analyzed semantics.

The step of converting the second text to the second speech specifically further includes: transmitting, through the second wireless network, the second text to a text-to-speech server, so as to convert the second text to the second speech through the text-to-speech server.

Optionally, in other embodiments of the present disclosure, after the step of converting the first speech to the first text, the control method further includes: generating real-time chat logs according to the first text and the image data, and storing the real-time chat logs in a storage server or a database configured on the smart mobile terminal; displaying, through a display screen, the real-time chat logs; after obtaining the second text, associating the second text with the real-time chat logs in the database or the storage server; and displaying, through the display screen, the reply in the second text. The display screen may be a built-in or external display screen of the smart mobile terminal.

The step of obtaining the chat history of the user, specifically further includes: obtaining the chat history during the current chat from the database or the storage server.

Optionally, in other embodiments of the present disclosure, the prompt information is used for prompting the LLMs to perform at least one of the following tasks based on the image data: image identification, information sharing, phone calling, navigation, internet searching, web service calling, and translation.

The following will further elaborate on the aforementioned smart glasses control system and smart wearable device control method by incorporating multiple application examples.

### Application example 1

The LLMs are configured on the server 130. The smart glasses 110 are used for obtaining the speech, playing the speech and capturing the image data. The smart phone or smart watch 120 is used for GPS positioning. The cloud server is used for, converting the speech to the text, converting the text to the speech, obtaining the chat history, generating the prompt information, and obtaining the reply to the question of the user through the LLMs. Alternatively, the prompt information may be generated by the smart phone or smart watch 120.

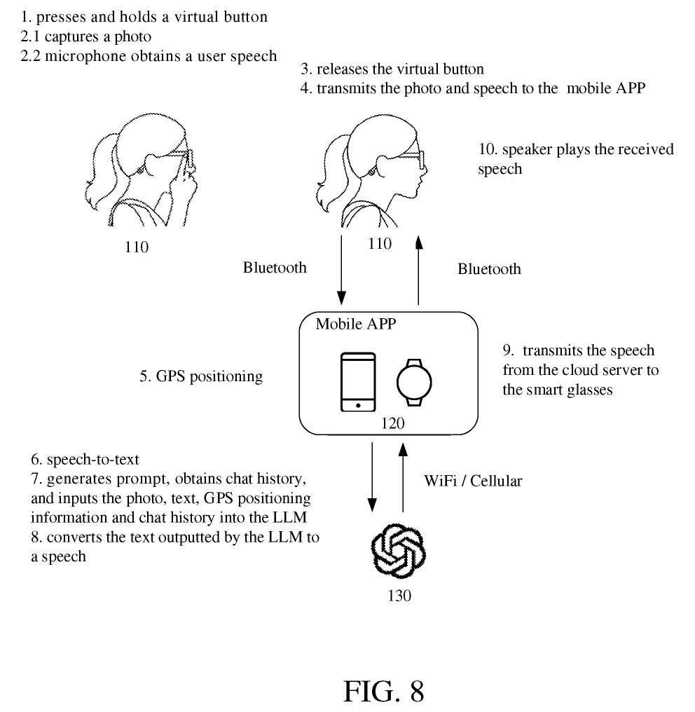

As shown in FIG. 8, the user enables the chat feature by the mobile application (APP) or virtual assistant program (such as Siri/OK Google, etc.) running on the smart phone or smart watch 120. When the user presses and holds the touch-sensor-based virtual button on the temple of the smart glasses 110, the smart glasses 110 call the built-in camera to capture a photo, and at the same time, the smart glasses 110 further output a notification sound through the built-in speaker to prompt the user that the microphone on the smart glasses 110 is ready to listen to the user's speech.

The user asks a question such as "Where in Hong Kong was this photo captured?" with voice while pressing and holding the virtual button, and the smart glasses 110 obtain the first speech including the question through the microphone. When the user releases the virtual button, the smart glasses 110 transmit the first speech and the captured image to the mobile APP on the smart phone or smart watch 120 through the Bluetooth, and output another notification sound to prompt that the user's task request has been transmitted.

Then, the mobile APP obtains the GPS positioning information, and transmits the first speech, the image and the GPS positioning information to the cloud server 130. The cloud server 130 converts the first speech to the first text, performs the semantic analysis on the first text to obtain the analyzed semantics, generates the prompt information based on the analyzed semantics, and obtains the chat history of the user. The chat history may include, for example, after the chat feature is enabled and before the current time point, the text corresponding to the user speech obtained during the user's last chat session with the LLMs, and/or the photo(s) transmitted during the user's last chat session with the LLMs. It is understandable that a Q&A between the user and the LLMs may be defined as a chat.

Then, the cloud server 130 inputs the captured photo, the first text, the prompt information, the GPS positioning information and the chat history into the LLMs, obtains the second text including a reply to the user's question outputted from the LLMs, converts the second text to the second speech, and transmits the second speech to the smart phone or smart watch 120. The smart phone or smart watch 120 transmits the second speech to the smart glasses 110 through the Bluetooth, so that the smart glasses 110 play the second speech through the built-in speaker.

Then, the user may continue to ask the next question, until the user disables the chat feature through the mobile APP.

Further, the user may set his/her language through the mobile APP. Alternatively, the user's language may be automatically detected through the speech-to-text engine, and the prompt information generated by the cloud server 130 further includes the information of the user's language.

Further, the user may set up the playback speed of the second speech through the mobile APP. For example, the user may set the playback speed to, normal, 1.25x (fast or slow), 1.5x (fast or slow), or 2x (fast or slow).

Further, during the activation of the chat function, the smart phone or smart watch 120 may generate real-time chat logs based on the received data, display the real-time chat logs for the user through the mobile APP, associate the real-time chat logs with the user account, and store the real-time chat logs in the chat history database. The chat history database may be configured on the storage server, or on the smart phone or smart watch.

Further, according to actions of the user on the mobile APP, the smart phone or smart watch 120 may further export the chat logs specified by the actions of the user as a file to a social media platform, such as Facebook, etc.

Further, the user may view, through the mobile APP, the complete chat history, or the chat history with the specified date or content.

Further, when the smart glasses 110 play the second speech, the user may increase the volume by sliding his or her finger(s) on the temple of the smart glasses 110 towards his or her ear, or the user may decrease the volume by sliding his or her finger(s) on the temple in a direction away from his or her ear.

### Application example 2

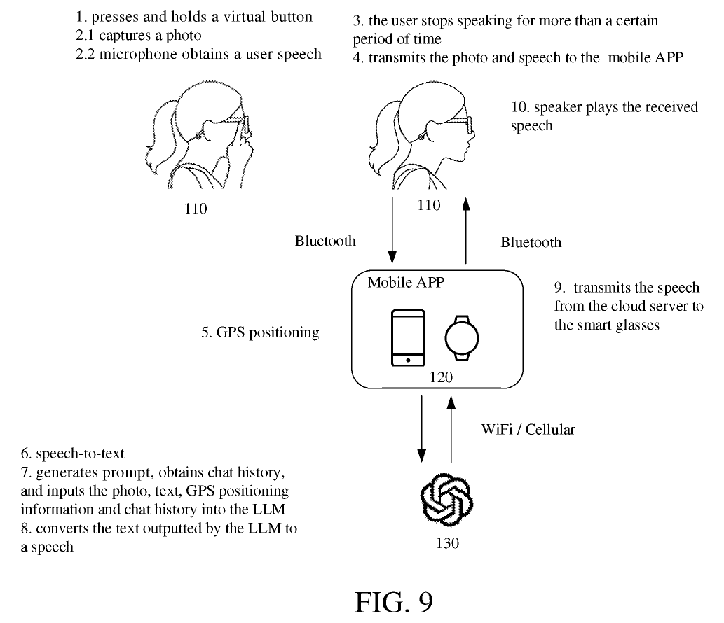

The LLMs are configured on the server 130. As shown in FIG. 9, unlike the application example 1, in the application example 2, when the user stops speaking for more than a certain period of time (i.e., the idle time of the microphone exceeds the preset time), the smart glasses 110 stop picking up speech, and transmit the first speech and the captured photo to the smart phone or smart watch 120.

### Application example 3

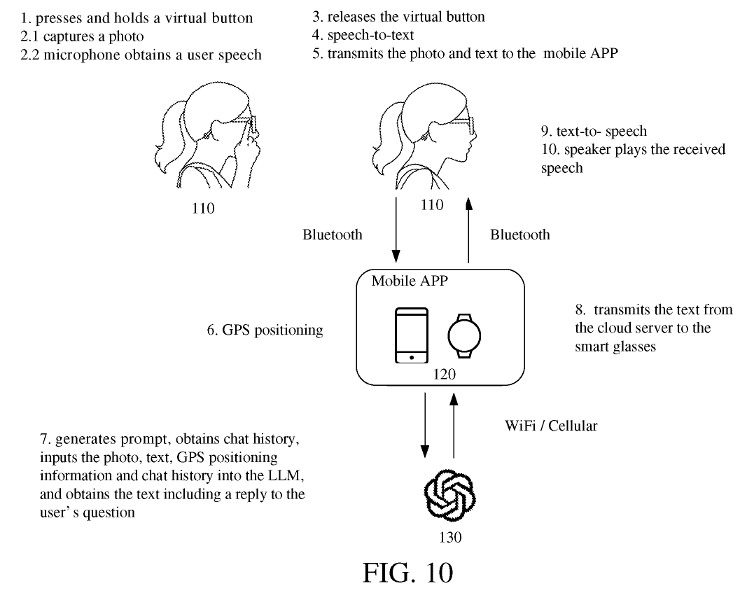

The LLMs are configured on the server 130. As shown in FIG. 10, unlike the application example 1, in the application example 3, the smart glasses 110 are used for: obtaining the speech, playing the speech, capturing the photo, converting the speech to the text, and converting the text to the speech; the smart phone or smart watch 120 is used for the GPS positioning; and the cloud server 130 is used for: generating the prompt information, obtaining the chat history, and obtaining the reply to the user's question through the LLMs.

### Application example 4

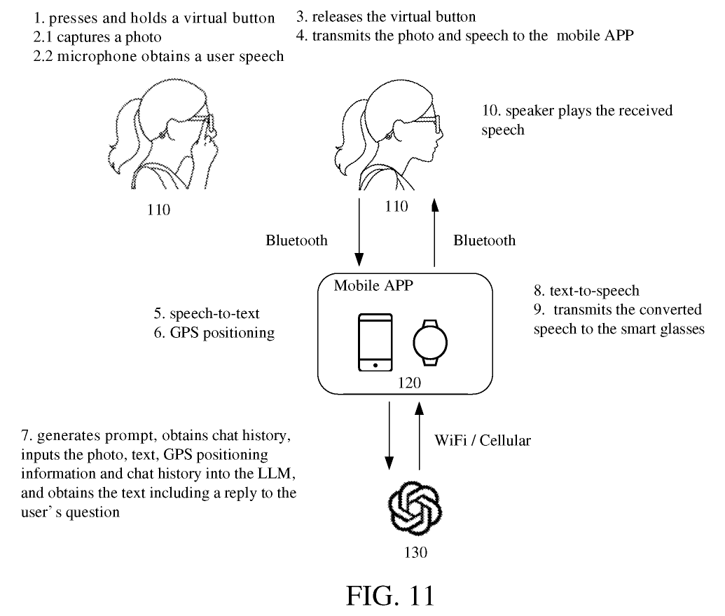

The LLMs are configured on the server 130. As shown in FIG. 11, unlike the application example 1, in the application example 4, the smart glasses 110 are used for: obtaining the speech, playing the speech, and capturing the image data; the smart phone or smart watch 120 is used for: the GPS positioning, converting the speech to the text, and converting the text to the speech; and the cloud server 130 is used for: generating the prompt information, obtaining the chat history, and obtaining the reply to the user's question through the LLMs.

### Application example 5

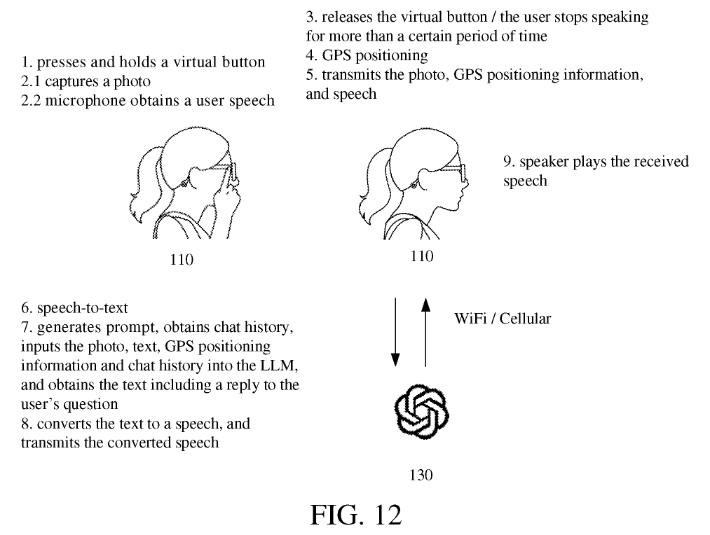

The LLMs are configured on the server 130. As shown in FIG. 12, unlike the application example 1, in the application example 5, the smart glasses 110 communicate directly with the cloud server 130; the smart glasses 110 are used for: obtaining the speech, playing the speech, the GPS positioning, and capturing the image data; the cloud server 130 is used for: converting the speech to the text, converting the text to the speech, generating the prompt information, obtaining the chat history, and obtaining the reply to the user's question through the LLMs.

For details not covered in the above-mentioned embodiments of the smart wearable device control method based on LLMs, please refer to the relevant descriptions in the above-mentioned embodiments shown in FIGS. 1 to 6, which will not be described again here.

In the embodiment, by using the LLMs, the human-machine task interactions based on capturing image data are realized on the smart wearable device, thereby enriching the functions of the smart wearable device. Furthermore, due to the scalability and self-creativity of the LLMs, the intelligence and interactivity of the smart wearable device can be further improved.

The present disclosure further provides a non-transitory computer-readable storage medium, which can be set in the smart mobile terminal or smart wearable device in the above-mentioned embodiments, and may be the memory 206 in the embodiment shown in FIG. 5. The computer-readable storage medium stores one or more computer programs. When the one or more programs are executed by the processor, all or part of the smart wearable device control method based on LLMs, in the above-mentioned embodiment(s) is performed. Further, the computer-readable storage medium may also be a USB flash drive, a mobile hard disk, a read-only memory (ROM), a Random Access Memory (RAM), a disk, or a CD-ROM, or any medium capable of storing program code.

It should be understood that in the above-described embodiments of the present disclosure, the above-mentioned smart glasses, smart glasses control system and smart wearable device control method based on LLMs may be implemented in other manners. For example, multiple units/modules may be combined or be integrated into another system, or some of the features may be ignored or not performed. In addition, the above-mentioned mutual coupling/connection may be direct coupling/connection or communication connection, and may also be indirect coupling/connection or communication connection through some interfaces/devices, and may also be electrical, mechanical or in other forms.

It should be noted that for the various embodiments of the smart wearable device control method based on LLMs described above, for the sake of simplicity, they are described as a series of action combinations. However, those skilled in the art should understand that the present disclosure is not limited by the order of the described actions, as certain steps can be performed in a different order or simultaneously. Additionally, it should be understood that the embodiments described in this invention are preferred embodiments, and the actions and modules involved are not necessarily required for the present disclosure.

In the above-mentioned embodiments, the descriptions of each embodiment have different focuses. For portions not described in a particular embodiment, reference can be made to relevant descriptions in other embodiments.

The above is a description of the smart glasses, smart glasses control system and smart wearable device control method based on LLMs provided by the present disclosure. Those skilled in the art should understand that based on the embodiments of the present disclosure, there may be changes in specific implementation methods and application scope. Therefore, the content of this specification should not be construed as limiting the present disclosure.

What is claimed is:

1. A smart glasses control system based on large language models (LLMs), comprising: smart glasses, a smart mobile terminal and a cloud server, wherein the smart glasses comprise: a microphone, a speaker, a camera and a wireless component, and the LLMs are configured on the cloud server or in the smart mobile terminal;
the smart glasses are configured for: obtaining, through the camera, image data comprising at least one photo or video, obtaining, through the microphone, a first speech of a user, and transmitting, through the wireless component, the image data and the first speech to the smart mobile terminal, wherein the first speech comprises a question asked by the user;
the smart mobile terminal is configured for: transmitting the first speech and the image data to the cloud server;
the cloud server is configured for: converting the first speech to a first text; performing semantic analysis on the first text, obtaining analyzed semantics, and generating prompt information based on the analyzed semantics; obtaining, through the LLMs, a second text according to the first text, the prompt information and the image data, wherein the second text comprises a reply to the question; converting the second text to a second speech; and transmitting the second speech to the smart mobile terminal;
the smart mobile terminal is further configured for transmitting the second speech to the smart glasses; and
the smart glasses are further configured for, receiving the second speech through the wireless component, and playing the second speech through the speaker.

2. The smart glasses control system of claim 1, wherein
the smart mobile terminal is further configured for: obtaining positioning information, and transmitting the positioning information, the first speech and the image data to the cloud server, wherein the positioning information is obtained by a satellite positioning system built into the smart mobile terminal, or wherein the positioning information is obtained by the smart glasses, and is transmitted from the smart glasses to the smart mobile terminal; and
the cloud server is further configured for, obtaining, through the LLMs, the second text according to the positioning information, the first text, the prompt information and the image data.

3. The smart glasses control system of claim 1, wherein the cloud server is further configured for: obtaining chat history, and obtaining, through the LLMs, the second text according to the chat history, the first text, the prompt information and the image data.

4. The smart glasses control system of claim 3, wherein
the smart mobile terminal is further configured for: obtaining positioning information, and transmitting the positioning information, the first speech and the image data to the cloud server, wherein the positioning information is obtained by a satellite positioning system built into the smart mobile terminal, or wherein the positioning information is obtained by the smart glasses, and is transmitted from the smart glasses to the smart mobile terminal; and
the cloud server is further configured for: obtaining the chat history, and obtaining, through the LLMs, the second text according to the chat history, the positioning information, the first text, the prompt information and the image data.

5. The smart glasses control system of claim 4, wherein the cloud server comprises a model server, and the LLMs are configured on the model server;
the smart mobile terminal is further configured for:
converting the first speech to the first text, performing the semantic analysis on the first text, obtaining the analyzed semantics, and generating the prompt information based on the analyzed semantics; and
transmitting the positioning information, the first text, the prompt information and the image data to the model server; and
the model server is configured for:
obtaining the chat history;
obtaining, through the LLMs, the second text according to the chat history, the positioning information, the first text, the prompt information and the image data; and
transmitting the second text to the smart mobile terminal; and
the smart mobile terminal is further configured for converting the second text to the second speech.

6. The smart glasses control system of claim 5, wherein the cloud server further comprises: a speech-to-text server, a prompt server and a text-to-speech server, and the smart mobile terminal is further configured for:
transmitting the first speech to the speech-to-text server, so as to convert, through the speech-to-text server, the first speech to the first text;
transmitting the first text to the prompt server, so as to perform, through the prompt server, the semantic analysis on the first text, obtain the analyzed semantics, and generate the prompt information based on the analyzed semantics; and
transmitting the second text to the text-to-speech server, so as to convert, through the text-to-speech server, the second text to the second speech.

7. The smart glasses control system of claim 6, wherein the cloud server further comprises a storage server;
the smart mobile terminal is further configured for: generating real-time chat logs; and storing the real-time chat logs in a database configured on the smart mobile terminal, or transmitting the real-time chat logs to the storage server for storing;
the model server is further configured for: obtaining the chat history transmitted by the smart mobile terminal, or obtaining the chat history from the storage server.

8. The smart glasses control system of claim 4, wherein the cloud server further comprises: a model server, a speech-to-text server, a prompt server, a text-to-speech server and a storage server, and the LLMs are configured on the model server;
the model server is further configured for: generating real-time chat logs, and transmitting the real-time chat logs to the storage server for storing; and
the model server is further configured for:
obtaining the chat history from the storage server;
transmitting the first speech to the speech-to-text server, so as to convert, through the speech-to-text server, the first speech to the first text;
transmitting the first text to the prompt server, so as to perform, through the prompt server, the semantic analysis on the first text, obtain the analyzed semantics, and generate the prompt information based on the analyzed semantics; and
transmitting the second text to the text-to-speech server, so as to convert, through the text-to-speech server, the second text to the second speech.

9. The smart glasses control system of claim 4, wherein the cloud server comprises a model server, and the LLMs are configured on the model server;
the smart glasses are further configured for: converting the first speech to the first text, and transmitting the first text and the image data to the smart mobile terminal;
the smart mobile terminal is further configured for: performing the semantic analysis on the first text, obtaining the analyzed semantics, generating the prompt information based on the analyzed semantics, and transmitting the positioning information, the first text, the prompt information and the image data to the model server;
the model server is configured for: obtaining the chat history, and obtaining, through the LLMs, the second text according to the chat history, the positioning information, the first text, the prompt information and the image data; and transmitting the second text to the smart mobile terminal;
the smart mobile terminal is further configured for transmitting the second text to the smart glasses; and
the smart glasses are further configured for converting the second text to the second speech.

10. The smart glasses control system of claim 9, wherein the cloud server further comprises: a prompt server and a storage server;
the smart glasses are further configured for, transmitting the first text to the prompt server, so as to perform, through the prompt server, the semantic analysis on the first text, obtain the analyzed semantics, and generate the prompt information based on the analyzed semantics; and
the model server is further configured for obtaining the chat history from the storage server.

11. The smart glasses control system of claim 1, wherein,
the smart glasses further comprise a positioning component, and the smart glasses are further configured for: obtaining, through the positioning component, positioning information, and transmitting the first speech, the positioning information and the image data to the cloud server; and
the cloud server is further configured for, obtaining, through the LLMs, the second text according to the positioning information, the first text, the prompt information and the image data.

12. The smart glasses control system of claim 11, wherein,
the smart glasses are further configured for, transmitting the first speech to the smart mobile terminal, so as to generate, through the smart mobile terminal, the prompt information according to the first speech;
the smart glasses are further configured for, transmitting the prompt information, the first speech, the positioning information and the image data to the cloud server; and
the cloud server is further configured for: obtaining chat history, and obtaining, through the LLMs, the second text according to the chat history, the positioning information, the first text, the prompt information and the image data.

13. The smart glasses control system of claim 1, wherein the smart glasses further comprise at least one control button, the at least one control button comprises a physical button and/or a touch-sensor-based virtual button, and the smart glasses are further configured for:
in response to an activation command, activating chat feature on the smart glasses, wherein the activation command comes from the smart mobile terminal or a virtual assistant program installed on the smart glasses;
in response to a capture command, capturing, through the camera, the image data, wherein the capture command is triggered by the user through a capture button in the at least one control button;
outputting a first prompt sound to prompt the user to ask the question;
in response to a listen command, initiating the microphone to detect the first speech, wherein the listen command is triggered based on an event of the user pressing and holding a chat button in the at least one control button; and
in response to a stop command, stopping the detection of the first speech, and outputting a second prompt sound to prompt the user that the speech detection is stopped, wherein the stop command is triggered based on an event of the user releasing the chat button or an event of idle time of the microphone exceeding a preset time.

14. The smart glasses control system of claim 1, wherein the LLMs comprise: generative artificial intelligence large language models (GAILLMs) or multimodal large language models (MLLMs).

15. Smart glasses based on large language models (LLMs), comprising: a frame, at least one temple, a microphone, a speaker, at least one sensor, a processor and a memory;
wherein the at least one temple is connected to the frame, and the processor is electrically connected to the microphone, the speaker, the at least one sensor and the memory;
one or more computer programs executable on the processor are stored in the memory, and the one or more computer programs comprise:
instructions for: obtaining, through the at least one sensor, sensing data, wherein the at least one sensor comprises a camera, and the sensing data comprises image data captured by the camera, wherein the image data comprise at least one photo or video;
instructions for obtaining, through the microphone, a first speech of a user, wherein the first speech comprises a question asked by the user;
instructions for obtaining, through the LLMs, a second speech comprising a reply to the question, according to the first speech and the sensing data, wherein the LLMs are configured on the smart glasses, or a smart mobile terminal, or a cloud server; and
instructions for playing the second speech through the speaker.

16. The smart glasses of claim 15, wherein the smart glasses further comprise at least one control button electrically connected to the processor, the at least one control button comprises a physical button and/or a touch-sensor-based virtual button, and the one or more computer programs further comprise:
instructions for, in response to an activation command, activating chat feature on the smart glasses, wherein the activation command comes from the smart mobile terminal or a virtual assistant program installed on the smart glasses;
instructions for, in response to a capture command, capturing, through the camera, the image data, wherein the capture command is triggered by the user through a capture button in the at least one control button;
instructions for, outputting a first prompt sound to prompt the user to ask the question;
instructions for, in response to a listen command, initiating the microphone to detect the first speech, wherein the listen command is triggered based on an event of the user pressing and holding a chat button in the at least one control button; and
instructions for, in response to a stop command, stopping the detection of the first speech, outputting a second prompt sound to prompt the user that the speech detection is stopped, and obtaining, through the LLMs, the second speech comprising the reply to the question, according to the first speech and the sensing data, wherein the stop command is triggered based on an event of the user releasing the chat button or an event of idle time of the microphone exceeding a preset time.

17. The smart glasses of claim 16, wherein the at least one sensor further comprises a position sensor, the sensing data further comprises positioning data of the smart glasses, and the one or more computer programs further comprise:
instructions for, obtaining, through the position sensor, location information as the positioning data.

18. The smart glasses of claim 17, wherein the one or more computer programs further comprise:
instructions for: obtaining chat history of the user, and obtaining, through the LLMs, the second speech according to the first speech, the sensing data and the chat history.

19. The smart glasses of claim 18, wherein the smart glasses further comprise a second wireless component electrically connected to the processor, and the one or more computer programs further comprise:
instructions for, generating real-time chat logs;
instructions for: storing the real-time chat logs in the memory, or transmitting, through the second wireless component, the real-time chat logs to the storage server for storing; and
instructions for, obtaining the chat history from the memory or the storage server.

20. The smart glasses of claim 19, wherein the smart glasses further comprise a first wireless component electrically connected to the processor, and the one or more computer programs further comprise:
instructions for, obtaining, through the first wireless component, the positioning data from the smart mobile terminal;
instructions for, transmitting, through the second wireless component, the first speech to a speech-to-text server, so as to convert, through the speech-to-text server, the first speech to the first text;
instructions for, transmitting, through the second wireless component, the first text to a prompt server, so as to perform, through the prompt server, semantic analysis on the first text, obtain the analyzed semantics, and generate the prompt information based on the analyzed semantics;
instructions for, obtaining, through the LLMs, the second text comprising the reply to the question according to the prompt information, the first text, the sensing data and the chat history; and
instructions for, transmitting, through the second wireless component, the second text to a text-to-speech server, so as to convert, through the text-to-speech server, the second text to the second speech.

21. The smart glasses of claim 20, wherein the one or more computer programs further comprise: instructions for,
transmitting, through the first wireless component, the prompt information, the first text, the sensing data and the chat history to the smart mobile terminal, so as to obtain, through the LLMs on the smart mobile terminal, the second text comprising the reply to the question; or
transmitting, through the second wireless component, the prompt information, the first text, the sensing data and the chat history to the model server, so as to obtain, through the LLMs on the model server, the second text.

22. A computer-implemented smart wearable device control method based on large language models (LLMs), applied to a smart mobile terminal, wherein the control method comprises:
receiving, through a first wireless network, a first speech and image data transmitted by the smart wearable device, wherein the first speech comprises a question asked by a user, wherein the image data comprise at least one photo or video, and the first wireless network comprises a Bluetooth or WiFi network;
converting the first speech to a first text, performing semantic analysis on the first text, obtaining analyzed semantics, and generating prompt information based on the analyzed semantics;
obtaining, through the LLMs, a second text according to the image data, the first text and the prompt information, wherein the second text comprises a reply to the question, and the LLMs are configured on the smart mobile terminal or a cloud server; and
converting the second text to a second speech, and transmitting, through the first wireless network, the second speech to the smart wearable device for playing.

23. The control method of claim 22, further comprising:
obtaining positioning information and/or chat history of the user; and
obtaining, through the LLMs, the second text according to the image data, the first text, the prompt information, and the positioning information and/or chat history.

24. The control method of claim 23, wherein,
the step of converting the first speech to the first text, comprises:
transmitting, through a second wireless network, the first speech to a speech-to-text server, so as to convert, through the speech-to-text server, the first speech to the first text;
the step of performing the semantic analysis on the first text, obtaining the analyzed semantics, and generating the prompt information based on the analyzed semantics, comprises:
transmitting, through the second wireless network, the first text to a prompt server, so as to perform, through the prompt server, the semantic analysis on the first text, obtain the analyzed semantics and generate the prompt information based on the analyzed semantics; and
the step of converting the second text to the second speech, comprises:
transmitting, through the second wireless network, the second text to a text-to-speech server, so as to convert, through the text-to-speech server, the second text to the second speech.

25. The control method of claim 23, wherein after the step of converting the first speech to the first text, the control method further comprises:
generating real-time chat logs according to the first text and the image data, and storing the real-time chat logs in a storage server, or a database configured on the smart mobile terminal;
displaying, through a display screen, the real-time chat logs;
associating the second text with the real-time chat logs in the database or the storage server, after obtaining the second text; and
displaying, through the display screen, the reply in the second text; and
wherein the step of obtaining the chat history of the user comprises:
obtaining the chat history during the current chat from the database or the storage server.

26. The control method of claim 23, wherein the prompt information is configured for prompting the LLMs to perform at least one of the following tasks based on the image data:
image identification, information sharing, phone calling, navigation, internet searching, web service calling, and translation.
